(19) United States
(12) Patent Application Publication
(10) Pub. No.: US 2026/0257418 A1
(43) Pub. Date: Sep. 3, 2026

(54) THREE DIMENSIONAL MOLDING DEVICE AND MATERIAL EJECTION HEAD

(71) Applicant: SEIKO EPSON CORPORATION, Tokyo (JP)

(72) Inventors: Daizo AOYAGI, SHIOJIRI-SHI (JP); Tatsuya TSUBOI, OKAYA-SHI (JP); Keitaro HASHIZUME, SHIOJIRI-SHI (JP)

(73) Assignee: SEIKO EPSON CORPORATION, Tokyo (JP)

(21) Appl. No.: 19/553,470

(22) Filed: Mar. 2, 2026

(30) Foreign Application Priority Data
Mar. 3, 2025 (JP) 2025-032530

(51) Int. Cl. B29C 64/209; B29C 64/295; B29C 64/321; B33Y 30/00

(52) U.S. Cl. CPC B29C 64/209; B29C 64/295; B29C 64/321; B33Y 30/00

(57) ABSTRACT

A three dimensional molding device includes a material supply section, a first ejection section and a second ejection section to eject a material, and a stage having a molding surface on which the material is deposited. The first ejection section has a first supply port and a first flow path and a first nozzle section communicating with the first flow path and has a first nozzle and a second nozzle to eject the material. The second ejection section has a second supply port and a second flow path and a second nozzle section communicating with the second flow path and has a third nozzle and a fourth nozzle to eject the material. Among the first nozzle section and the second nozzle section, at least the first nozzle, the second nozzle, the third nozzle, and the fourth nozzle are formed in a single member.

The present application is based on, and claims priority from JP Application Serial Number 2025-032530, filed March 3, 2025, the disclosure of which is hereby incorporated by reference herein in its entirety.

### BACKGROUND

### 1. Technical Field

The present disclosure relates to a three dimensional molding device and a material ejection head.

### 2. Related Art

JP-A-2023-161368 discloses a three dimensional molding device including a tip end section in which a plurality of nozzle holes are formed as an ejection section that ejects a molding material.

As a means for improving the molding speed, there is a method of increasing the number of nozzles by arranging a plurality of ejection sections each having a plurality of nozzles. However, when the plurality of ejection sections are arranged, the ejection sections may be deformed due to a temperature change of the ejection sections caused by eject of the material or the like, and the ejection sections may interfere with each other or a gap may be generated between the ejection sections. By this, it may cause a decrease in molding accuracy.

### SUMMARY

According to a first aspect of the present disclosure, a three dimensional molding device is provided. This three dimensional molding device includes a material supply section configured to supply a material; a first ejection section and a second ejection section that communicate with the material supply section and that are configured to eject the material; and a stage having a molding surface on which the material ejected from the first ejection section and the second ejection section are deposited, wherein the first ejection section has a first flow path forming section having a first supply port that communicates with the material supply section and to which the material is supplied, and a first flow path that communicates with the first supply port and a first nozzle section that communicates with the first flow path and that has a first nozzle and a second nozzle, which are configured to eject the material, the second ejection section has a second flow path forming section having a second supply port that communicates with the material supply section and to which the material is supplied, and a second flow path that communicates with the second supply port and a second nozzle section that communicates with the second flow path and that has a third nozzle and a fourth nozzle that are configured to eject the material, the first nozzle, the second nozzle, the third nozzle, and the fourth nozzle are arranged along a first direction parallel to the molding surface, and among the first nozzle section and the second nozzle section, at least the first nozzle, the second nozzle, the third nozzle, and the fourth nozzle are formed in a single member.

According to a second aspect of the present disclosure, a material ejection head is provided that ejects a material with respect to a stage.

This material ejection head includes a first ejection section and a second ejection section configured to eject the material, wherein the first ejection section has a first flow path forming section having a first supply port to which the material is supplied and a first flow path communicating with the first supply port and a first nozzle section that communicates with the first flow path and that has a first nozzle and a second nozzle, which are configured to eject the material, the second ejection section has a second flow path forming section having a second supply port to which the material is supplied and a second flow path communicating with the second supply port and a second nozzle section that communicates with the second flow path and that has a third nozzle and a fourth nozzle that are configured to eject the material, the first nozzle, the second nozzle, the third nozzle, and the fourth nozzle are arranged along a first direction parallel to a surface of the stage, and among the first nozzle section and the second nozzle section, at least the first nozzle, the second nozzle, the third nozzle, and the fourth nozzle are formed in a single member.

### BRIEF DESCRIPTION OF THE DRAWINGS

FIG. 1 is an explanatory diagram illustrating a schematic configuration of a three dimensional molding device.

FIG. 2 is a perspective view illustrating a schematic configuration of a screw.

FIG. 3 is a side view of a material ejection section.

FIG. 4 is a bottom view of the material ejection section.

FIG. 5 is a cross-sectional view taken along line V-V illustrated in FIG. 3.

FIG. 6 is a diagram illustrating a state in which a pressing section presses a plasticized material deposited on a molding surface.

FIG. 7 is a diagram illustrating a shape of a lower surface of a first nozzle fixing section and a second nozzle fixing section.

FIG. 8 is a cross-sectional view taken along line V-V illustrated in FIG. 3 in a second embodiment.

FIG. 9 is a cross-sectional view taken along line V-V illustrated in FIG. 3 in a third embodiment.

FIG. 10 is a diagram illustrating the shape of the lower surface of the first nozzle fixing section and the second nozzle fixing section in the third embodiment.

FIG. 11 is a cross-sectional view taken along line V-V illustrated in FIG. 3 in a fourth embodiment.

FIG. 12 is an explanatory diagram illustrating a schematic configuration of the three dimensional molding device according to a fifth embodiment.

FIG. 13 is a cross-sectional view taken along a line V-V illustrated in FIG. 3 in the fifth embodiment.

### DESCRIPTION OF EMBODIMENTS

### A. First Embodiment

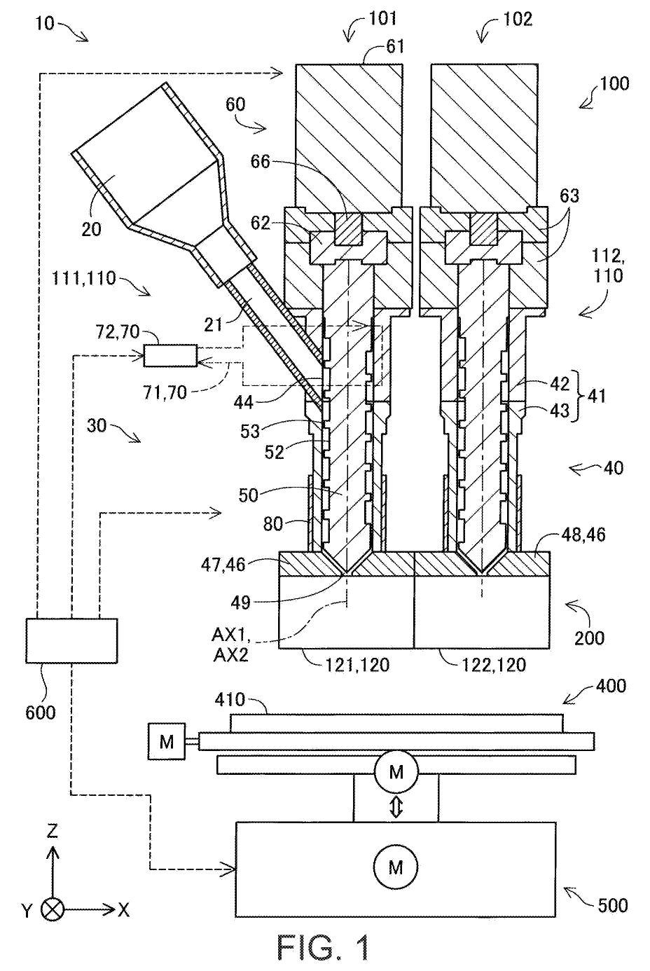

FIG. 1 is an explanatory diagram illustrating a schematic configuration of a three dimensional molding device 10. In FIG. 1, arrows indicating X, Y, and Z directions orthogonal to each other are illustrated. An X direction and a Y direction are directions parallel to a horizontal plane. A Z direction is a direction parallel to a vertical direction. The X, Y, and Z directions in FIG. 1 and the X, Y, and Z directions in other drawings indicate the same directions. When a direction is specified, positive and negative signs are used together with the direction notation, wherein the positive direction, which is the direction indicated by the arrow, is "+" and the negative direction, which is the direction opposite to the direction indicated by the arrow, is "-". The +Z direction is also referred to as "upper", and the -Z direction is also referred to as "lower".

The three dimensional molding device 10 includes a material ejection head 100, a stage 400, a movement mechanism 500, and a control section 600. The three dimensional molding device 10 molds, under the control of the control section 600, a three dimensional molded object in which layers of a plasticized material are laminated on a molding surface 410 by driving the movement mechanism 500 to change a relative position between an ejection section 120 and the molding surface 410 while ejecting the plasticized material, which is a material plasticized from the ejection section 120 of the material ejection head 100 (to be described later), toward the molding surface 410 of the stage 400.

The stage 400 is supported by the movement mechanism 500. The stage 400 has the molding surface 410 facing the ejection section 120 of the material ejection head 100. The molding surface 410 is provided parallel to the horizontal plane. The plasticized material ejected from the ejection section 120 is deposited on the molding surface 410.

The movement mechanism 500 changes the relative position between the ejection section 120 of the material ejection head 100 and the molding surface 410. In the present embodiment, the movement mechanism 500 supports the stage 400, and changes the relative position between the ejection section 120 and the molding surface 410 by moving the stage 400 with respect to the material ejection head 100. The movement mechanism 500 in the present embodiment is configured by a three axis positioner that moves the stage 400 in three axial directions of the X, Y, and Z directions by driving forces of three motors. Each motor is driven under the control of the control section 600. Note that the movement mechanism 500 may be configured to change the relative position between the ejection section 120 and the molding surface 410 by moving the material ejection head 100 without moving the stage 400, instead of moving the stage 400. The movement mechanism 500 may be configured to change the relative position between the ejection section 120 and the molding surface 410 by moving both the stage 400 and the material ejection head 100.

The control section 600 is configured by a computer including one or more processors, a storage device, and an input/output interface that inputs and outputs signals to and from the outside. The control section 600 exhibits various functions such as a function of executing a molding process for molding the three dimensional molded object by the processor executing a program or a command read on a main storage device. Note that the control section 600 may be realized by a configuration in which a plurality of circuits for realizing at least a part of each function are combined instead of being configured by the computer.

The material ejection head 100 ejects the plasticized material obtained by plasticizing the material in a solid state onto the molding surface 410 of the stage 400 under the control of the control section 600. Note that the term "plasticizing" is a concept including melting, and means changing from a solid to a state having fluidity. Specifically, in the case of a material in which glass transition occurs, plasticization means that the temperature of the material is set to be equal to or higher than the glass transition point. In the case of a material in which glass transition does not occur, plasticization means that the temperature of the material is raised to or higher than the melting point.

The material ejection head 100 includes a first head 101 and a second head 102. The first head 101 and the second head 102 are provided side by side in the horizontal direction. In the present embodiment, the first head 101 and the second head 102 are provided side by side in the X direction. The first head 101 includes a first material supply section 111 and a first ejection section 121. The second head 102 includes a second material supply section 112 and a second ejection section 122. The structure of the first material supply section 111 and the structure of the second material supply section 112 are the same. Hereinafter, when the material supply sections are referred to without distinction, they are simply referred to as a material supply section 110. When the ejection sections are referred to without distinction, they are simply referred to as ejection section 120. A portion including the first ejection section 121 and the second ejection section 122 is also referred to as a material ejection section 200. The detailed configuration of the material ejection section 200 will be described later.

The material supply section 110 includes a hopper 20 and a plasticizing section 30. The hopper 20 accommodates a material in the form of pellets. As the material, for example, a thermoplastic resin such as a polypropylene resin (PP), a polyethylene resin (PE), a polyacetal resin (POM), or a polyphenylene sulfide resin (PPS) is used. A communication path 21 that connects the hopper 20 and the plasticizing section 30 is provided below the hopper 20. The communication path 21 is connected to a cylinder 40 (to be described later) from obliquely above. The communication path 21 has a cylindrical shape. The hopper 20 supplies the material to the plasticizing section 30 through the communication path 21. In FIG. 1, the hopper 20 and the communication path 21 of the second material supply section 112 are omitted. Note that in FIG. 1, the communication path 21 of the first material supply section 111 is connected to the cylinder 40 from the -X direction side, but the connection direction of the communication path 21 with respect to the cylinder 40 is not particularly limited.

The plasticizing section 30 plasticizes at least a part of the material supplied from the hopper 20, generates a pasty plasticized material having fluidity, and guides the plasticized material to the ejection section 120. The plasticizing section 30 includes the cylinder 40, a screw 50, a screw drive section 60, a cooling section 70, and a cylinder heating section 80. The screw drive section 60, the cylinder 40, and the ejection section 120 are disposed in this order from the upper side to the lower side.

The cylinder 40 includes a main body section 41 and a nozzle fixing section 46 provided at a lower end of the main body section 41. The main body section 41 has a cylindrical shape centered on the central axis AX1. The main body section 41 is disposed such that the central axis AX1 extends along the vertical direction. The main body section 41 includes a first portion 42 and a second portion 43 positioned below the first portion 42. A supply port 44 to which the material is supplied from the material supply section 110 through the communication path 21 is provided in a connection section between the first portion 42 and the second portion 43. Note that the supply port 44 may be provided in the first portion 42. An upper end of the first portion 42 is formed in a flange shape. The screw drive section 60 is fixed to the upper end of the first portion 42. The nozzle fixing section 46 is fixed to a lower end of the second portion 43. A through hole 49 penetrating the nozzle fixing section 46 along the Z direction is provided at the center of the nozzle fixing section 46. The ejection section 120 is connected to the lower end of the nozzle fixing section 46.

In the present embodiment, the first portion 42, the second portion 43, and the nozzle fixing section 46 are each formed of stainless steel. In the present embodiment, the first portion 42 and the second portion 43 are integrally formed. For example, the first portion 42 and the second portion 43 can be integrally formed by bonding the first portion 42 and the second portion 43 using a metal bonding technique such as diffusion bonding or Hot Isostatic Press (HIP) bonding. The first portion 42 and the second portion 43 may be integrally formed using a three dimensional molding technique. Note that at least one of the first portion 42 and the second portion 43 may be formed of, for example, another metal material such as a titanium alloy, a resin material, or a ceramic material, instead of stainless steel. The first portion 42 and the second portion 43 may be formed of different metal materials.

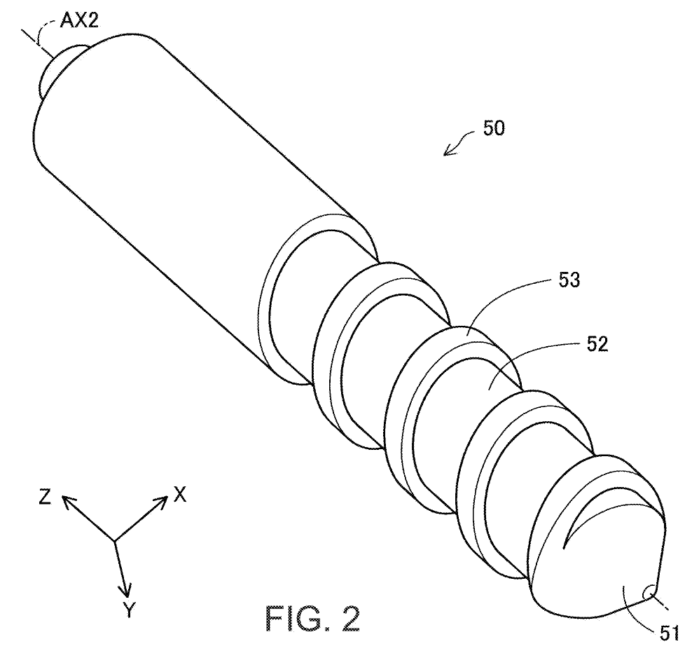

FIG. 2 is a perspective view illustrating a schematic configuration of the screw 50. Hereinafter, the configuration of the screw 50 will be described with reference to FIG. 1 and FIG. 2. The screw 50 is accommodated inside the cylinder 40. More specifically, the screw 50 is accommodated in a space surrounded by the main body section 41 of the cylinder 40, the nozzle fixing section 46 of the cylinder 40, and a gear case 63 of the screw drive section 60 (to be described later). The screw 50 has a shaft shape centered on the rotation axis AX2. The screw 50 is disposed such that the rotation axis AX2 is along the central axis AX1 of the main body section 41 of the cylinder 40. An upper end of the screw 50 is connected to the screw drive section 60. A tip end section 51 of the screw 50 is positioned near the through hole 49. A helical groove section 52 is formed in a side surface portion of the screw 50 around the rotation axis AX2. The groove section 52 is continuously provided from a portion of the screw 50 positioned above the supply port 44 to the tip end section 51 of the screw 50. Between the grooves 52, a helical flight section 53 is provided to separate the groove sections 52 from each other. Note that a plurality of groove sections 52 may be provided in the side surface portion of the screw 50. For example, two groove sections 52 may be provided in a double helical shape on the side surface portion of the screw 50. In the present embodiment, the screw 50 is formed of stainless steel subjected to quenching treatment. Note that the screw 50 may be formed of, for example, another metal material such as a titanium alloy, a resin material, or a ceramic material, instead of the stainless steel subjected to the quenching treatment.

The screw drive section 60 illustrated in FIG. 1 includes a drive motor 61, a decelerator 62, and the gear case 63. The gear case 63 is fixed to the upper end of the first portion 42 of the cylinder 40. The gear case 63 accommodates the decelerator 62. The drive motor 61 is fixed to an upper surface of the gear case 63. In the present embodiment, a servo motor is used as the drive motor 61. In the present embodiment, the decelerator 62 is configured by a gear or the like. The drive motor 61 is driven under the control of the control section 600. A rotation shaft 66 of the drive motor 61 is connected to the upper end portion of the screw 50 via the decelerator 62. The screw 50 rotates around the rotation axis AX2 of the cylinder 40 by the torque applied from the drive motor 61 via the decelerator 62. Note that, for example, a stepping motor may be used as the drive motor 61. The decelerator 62 may be configured by a pulley, a belt, or the like. The screw drive section 60 may not include the decelerator 62 and the gear case 63, and the rotation shaft 66 of the drive motor 61 may be connected to the upper end portion of the screw 50.

The cooling section 70 includes a refrigerant flow path 71 through which a refrigerant flows and a refrigerant supply section 72. The refrigerant flow path 71 is provided in the cylinder 40. The refrigerant flow path 71 is provided inside the first portion 42 as a three dimensional path passing through the vicinity of the supply port 44. The refrigerant flow path 71 is formed by a hole having the three dimensional path provided in the first portion 42. Both ends of the refrigerant flow path 71 are connected to the refrigerant supply section 72 via a pipe or the like. The refrigerant supply section 72 is configured by a chiller that removes heat from the refrigerant flowing through the refrigerant flow path 71 while circulating the refrigerant in the refrigerant flow path 71. The refrigerant supply section 72 is driven under the control of the control section 600. In the present embodiment, water is used as the refrigerant. Note that, as the refrigerant, for example, oil or air may be used instead of water. Only one end of the refrigerant flow path 71 may be connected to the refrigerant supply section 72, instead of both ends of the refrigerant flow path 71. In this case, for example, the refrigerant may be discharged from the other end of the refrigerant flow path 71 to the outside.

The cylinder heating section 80 heats the material supplied into the cylinder 40. The cylinder heating section 80 is an electric heater. The cylinder heating section 80 is provided along a portion of the surface of an outer periphery of the second portion 43, the portion being positioned between the supply port 44 and the ejection section 120. Note that the cylinder heating section 80 may be embedded in the outer periphery of the second portion 43 positioned between the supply port 44 and the ejection section 120. The temperature of the cylinder heating section 80 is controlled by the control section 600. For example, the control section 600 may control the temperature of the cylinder heating section 80 using the temperature acquired by a temperature sensor provided in the cylinder heating section 80. Note that the cylinder heating section 80 is not limited to the electric heater, and may be a gas heating type heater or the like.

The first ejection section 121 is connected to a lower surface of the nozzle fixing section 46 of the first material supply section 111. The first ejection section 121 communicates with the first material supply section 111 and ejects the plasticized material generated in the first material supply section 111 toward the molding surface 410 of the stage 400. The second ejection section 122 is connected to a lower surface of the nozzle fixing section 46 of the second material supply section 112. The second ejection section 122 communicates with the second material supply section 112 and ejects the plasticized material generated in the second material supply section 112 toward the molding surface 410 of the stage 400. Hereinafter, the nozzle fixing section 46 of the first material supply section 111 is referred to as a first nozzle fixing section 47, and the nozzle fixing section 46 of the second material supply section 112 is referred to as a second nozzle fixing section 48. The first ejection section 121 and the second ejection section 122 are provided side by side in the horizontal direction. In the present embodiment, the first ejection section 121 and the second ejection section 122 are provided side by side in the X direction.

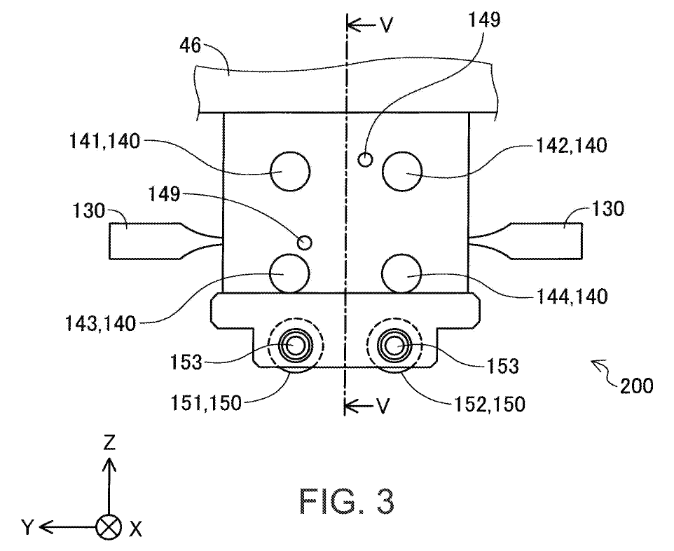

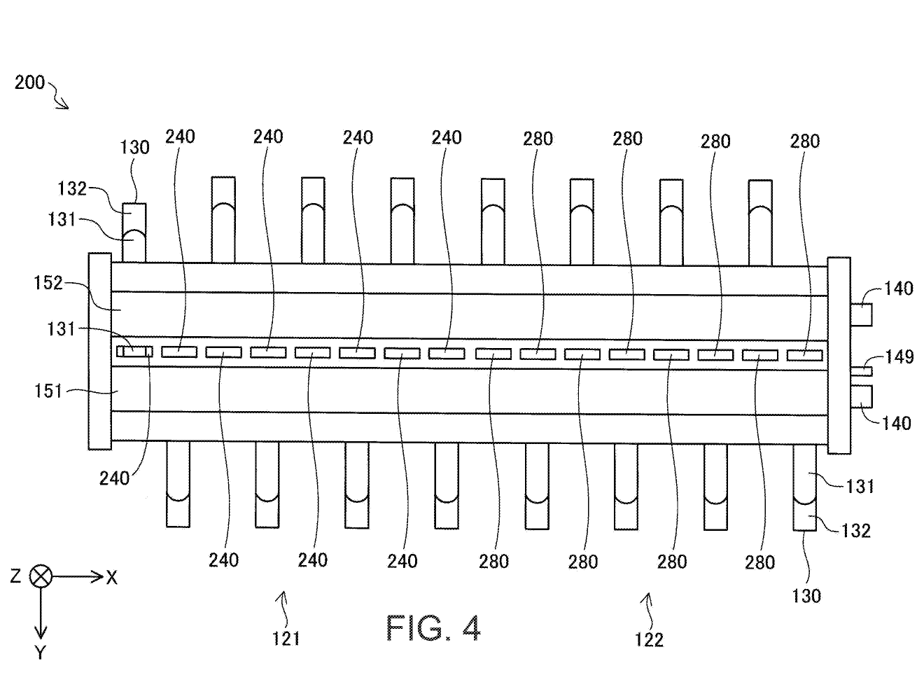

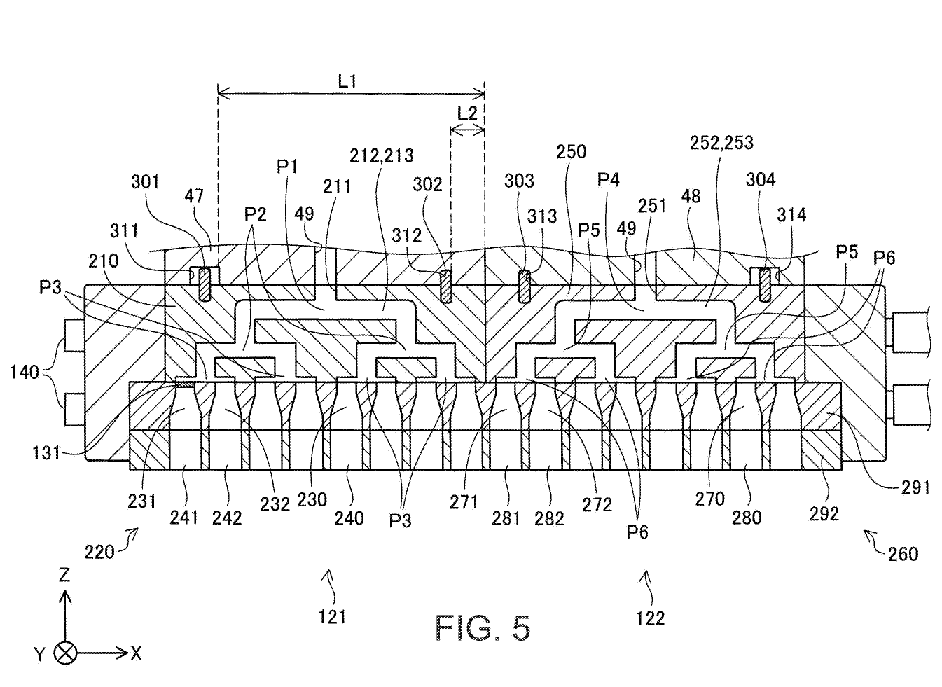

FIG. 3 is a side view of the material ejection section 200. FIG. 4 is a bottom view of the material ejection section 200. FIG. 5 is a cross-sectional view taken along line V-V illustrated in FIG. 3. The material ejection section 200 has the first ejection section 121, the second ejection section 122, an ejection adjusting section 130, a nozzle heating section 140, and a pressing section 150.

As illustrated in FIG. 5, the first ejection section 121 includes a first flow path forming section 210 and a first nozzle section 220. The first flow path forming section 210 and the first nozzle section 220 are formed on different members.

The first flow path forming section 210 has a first supply port 211 that communicates with the first material supply section 111 and to which the plasticized material is supplied, and a first flow path 212 that communicates with the first supply port 211. The first supply port 211 communicates with the through hole 49 of the first nozzle fixing section 47. That is, the first supply port 211 communicates with the plasticizing section 30. The first flow path 212 functions as a flow path that distributes the plasticized material supplied to the first supply port 211 to each nozzle included in the first nozzle section 220. The first flow path 212 extends from the first supply port 211 to a first branch point P1, and then branches into two flow paths extending in the +X direction and the -X direction at the first branch point P1. Each of the flow paths branched at the first branch point P1 extends to the second branch point P2, and then branches into two flow paths extending in the +X direction and the -X direction at the second branch point P2. Each of the flow paths branched at the second branch point P2 extends to the third branch point P3, and then branches into two flow paths extending in the +X direction and the -X direction at the third branch point P3. A portion of the first flow path 212 closer to the first ejection section 121 than the first branch point P1 is also referred to as a first branch flow path 213. That is, the first flow path 212 has the first branch flow path 213. The first flow path forming section 210 is formed of stainless steel. Note that the first flow path forming section 210 may be formed of, for example, another metal material such as a titanium alloy, a resin material, or a ceramic material, instead of stainless steel.

The first nozzle section 220 is provided below the first flow path forming section 210. The first nozzle section 220 has a plurality of nozzle flow paths 230 and a plurality of nozzles 240. In the present embodiment, the first nozzle section 220 includes eight nozzle flow paths 230 and eight nozzles 240. In the present specification, the nozzle 240 refers to a portion in the vicinity of a nozzle hole formed on a lower surface of the material ejection section 200, which is a hole through which the plasticized material is ejected. As illustrated in FIG. 4 and FIG. 5, the eight nozzles 240 included in the first nozzle section 220 are arranged along a first direction parallel to the molding surface 410 of the stage 400. In the present embodiment, the first direction is the X direction.

The nozzle flow path 230 of the first nozzle section 220 is formed along the Z direction. The eight nozzle flow paths 230 included in the first nozzle section 220 communicate with the eight flow paths branched in the first flow path forming section 210, respectively. Each of the eight nozzle flow paths 230 included in the first nozzle section 220 communicates with one different nozzle 240 included in the first nozzle section 220. In the present specification, among the eight nozzle flow paths 230 included in the first nozzle section 220, the nozzle flow path 230 positioned on the most -X direction side is referred to as a first nozzle flow path 231, and the nozzle flow path 230 positioned second from the most -X direction side is referred to as a second nozzle flow path 232. Among the eight nozzles 240 included in the first nozzle section 220, the nozzle 240 positioned on the most -X direction side is referred to as a first nozzle 241, and the nozzle 240 positioned second from the most -X direction side is referred to as a second nozzle 242. That is, the first nozzle section 220 includes the first nozzle flow path 231, the first nozzle 241, the second nozzle flow path 232, and the second nozzle 242. The first nozzle flow path 231 communicates with the first branch flow path 213 and the first nozzle 241, and the second nozzle flow path 232 communicates with the first branch flow path 213 and the second nozzle 242.

The second ejection section 122 includes a second flow path forming section 250 and a second nozzle section 260. The second flow path forming section 250 and the second nozzle section 260 are formed on different members.

The second flow path forming section 250 has a second supply port 251 that communicates with the second material supply section 112 and to which the plasticized material is supplied, and a second flow path 252 that communicates with the second supply port 251. The second supply port 251 communicates with the through hole 49 of the second nozzle fixing section 48. That is, the second supply port 251 communicates with the plasticizing section 30. The second flow path 252 functions as a flow path that distributes the plasticized material supplied to the second supply port 251 to each nozzle 280 included in the second nozzle section 260. The second flow path 252 extends from the second supply port 251 to a fourth branch point P4, and then branches into two flow paths extending in the +X direction and the -X direction at the fourth branch point P4. Each of the flow paths branched at the fourth branch point P4 extends to the fifth branch point P5, and then branches into two flow paths extending in the +X direction and the -X direction at the fifth branch point P5. Each of the flow paths branched at the fifth branch point P5 extends to the sixth branch point P6, and then branches into two flow paths extending in the +X direction and the -X direction at the sixth branch point P6. A portion of the second flow path 252 closer to the second ejection section 122 than the fourth branch point P4 is also referred to as a second branch flow path 253. That is, the second flow path 252 has the second branch flow path 253. The second flow path forming section 250 is formed of stainless steel. Note that the second flow path forming section 250 may be formed of, for example, another metal material such as a titanium alloy, a resin material, or a ceramic material, instead of stainless steel. Hereinafter, when the first flow path forming section 210 and the second flow path forming section 250 are referred to without distinction, they are simply referred to as flow path forming section.

The second nozzle section 260 is provided below the second flow path forming section 250. The second nozzle section 260 has a plurality of nozzle flow paths 270 and a plurality of nozzles 280. In the present embodiment, the second nozzle section 260 includes eight nozzle flow paths 270 and eight nozzles 280. As illustrated in FIG. 4 and FIG. 5, the eight nozzles 280 are arranged along the first direction.

The nozzle flow path 270 of the second nozzle section 260 is formed along the Z direction. The eight nozzle flow paths 270 included in the second nozzle section 260 communicate with the eight flow paths branched in the second flow path forming section 250, respectively. Each of the eight nozzle flow paths 270 included in the second nozzle section 260 communicates with one different nozzle 280 included in the second nozzle section 260. In the present specification, among the eight nozzle flow paths 270 included in the second nozzle section 260, the nozzle flow path 270 positioned on the most -X direction side is referred to as a third nozzle flow path 271, and the nozzle flow path 270 positioned second from the most -X direction side is referred to as a fourth nozzle flow path 272. Among the eight nozzles 280 included in the second nozzle section 260, the nozzle 280 positioned on the most -X direction side is referred to as a third nozzle 281, and the nozzle 280 positioned second from the most -X direction side is referred to as a fourth nozzle 282. That is, the second nozzle section 260 includes the third nozzle flow path 271, the third nozzle 281, the fourth nozzle flow path 272, and the fourth nozzle 282. The third nozzle flow path 271 communicates with the second branch flow path 253 and the third nozzle 281, and the fourth nozzle flow path 272 communicates with the second branch flow path 253 and the fourth nozzle 282.

The first nozzle section 220 and the second nozzle section 260 are formed across the first member 291 and the second member 292. The first member 291 and the second member 292 are flat plate-shaped members. The first member 291 is disposed below the first flow path forming section 210 and the second flow path forming section 250. The second member 292 is disposed below the first member 291. The nozzle holes that constitute the nozzles 240 of the first nozzle section 220 and the nozzles 280 of the second nozzle section 260 are formed in a lower surface of the second member 292. The first member 291 and the second member 292 are formed of stainless steel. Note that the first member 291 and the second member 292 may be formed of, for example, another metal material such as a titanium alloy, a resin material, or a ceramic material, instead of stainless steel.

The first member 291 is formed with the nozzle flow paths 230 of the first nozzle section 220 and the nozzle flow paths 270 of the second nozzle section 260. That is, the first member 291 is formed with the first nozzle flow path 231, the second nozzle flow path 232, the third nozzle flow path 271, and the fourth nozzle flow path 272. The first member 291 has formed therein a portion of the nozzle flow paths 230 and 270 that includes a portion that communicates with the flow path forming section.

The second member 292 is formed with the nozzle flow paths 230 of the first nozzle section 220, the nozzle flow paths 270 of the second nozzle section 260, the nozzles 240 of the first nozzle section 220, and the nozzles 280 of the second nozzle section 260. That is, the second member 292 is formed with the first nozzle flow path 231, the second nozzle flow path 232, the third nozzle flow path 271, the fourth nozzle flow path 272, the first nozzle 241, the second nozzle 242, the third nozzle 281, and the fourth nozzle 282. In other words, the first nozzle flow path 231, the second nozzle flow path 232, the third nozzle flow path 271, the fourth nozzle flow path 272, the first nozzle 241, the second nozzle 242, the third nozzle 281, and the fourth nozzle 282 are formed in a single member. In other words, the first nozzle section 220 and the second nozzle section 260 are integrated. In other words, the first ejection section 121 and the second ejection section 122 have a common nozzle section. The nozzle flow paths 230 and 270 formed in the second member 292 are portions that are positioned closer to the nozzles 240 and 280 than the nozzle flow paths 230 and 270 formed in the first member 291 and that communicate with the nozzles 240 and 280.

All the nozzles 240 and 280 included in the first nozzle section 220 and the second nozzle section 260 are arranged along the first direction. That is, the first nozzle 241, the second nozzle 242, the third nozzle 281, and the fourth nozzle 282 are arranged along the first direction. All the nozzles 240 and 280 included in the first nozzle section 220 and the second nozzle section 260 are arranged at regular intervals along the first direction. The nozzles 240 and 280 have the same size. As viewed in the +Z direction, each of the nozzles 240 and 280 has a rectangular shape. Note that the nozzles 240 and 280 may have different sizes. As viewed in the +Z direction, each nozzle 240 and 280 may be a circular shape, an elliptical shape, or a polygonal shape.

The ejection adjusting section 130 adjusts an eject amount of the plasticized material from the nozzles 240 and 280. The ejection adjusting section 130 is provided one by one in each nozzle flow path 230 and 270, and adjusts the eject amount of the plasticized material from the nozzles 240 and 280 communicating with each nozzle flow path 230 and 270. As illustrated in FIG. 4, the ejection adjusting section 130 has an insertion section 131 inserted into the nozzle flow paths 230 and 270 and a support section 132 that supports the insertion section 131. Each insertion section 131 is inserted into the nozzle flow paths 230 and 270 alternately from the +Y direction side and the -Y direction side along the X direction. FIG. 4 and FIG. 5 illustrate a state in which the insertion section 131 is inserted into the first nozzle flow path 231. As illustrated in FIG. 5, the insertion section 131 has a rectangular shape as viewed in the Y direction. The support section 132 is connected to a drive section (not illustrated). The drive section is configured by, for example, a motor, a compressor, and the like. The drive section is controlled by the control section 600. The support section 132 is moved in the Y direction by the driving of the drive section. The insertion of the insertion section 131 into the nozzle flow paths 230 and 270 and the removal of the insertion section 131 from the nozzle flow paths 230 and 270 are performed by the support section 132 moving in the Y direction.

The nozzle heating section 140 heats the plasticized material inside the first ejection section 121 and the second ejection section 122 by heating the first ejection section 121 and the second ejection section 122. The nozzle heating section 140 is, for example, a rod-shaped heater. The nozzle heating section 140 penetrates the first ejection section 121 and the second ejection section 122 in the X direction. In other words, the nozzle heating section 140 extends in the first direction. The temperature of the nozzle heating section 140 is controlled by the control section 600.

As illustrated in FIG. 3, the nozzle heating section 140 is configured by a first nozzle heating section 141, a second nozzle heating section 142, a third nozzle heating section 143, and a fourth nozzle heating section 144. The first nozzle heating section 141 and the second nozzle heating section 142 are arranged in the Y direction. The third nozzle heating section 143 and the fourth nozzle heating section 144 are arranged in the Y direction below the first nozzle heating section 141 and the second nozzle heating section 142. The first nozzle heating section 141 and the third nozzle heating section 143 are arranged in the Z direction. The second nozzle heating section 142 and the fourth nozzle heating section 144 are arranged in the Z direction. The ejection adjusting section 130 is positioned between the first nozzle heating section 141 and the third nozzle heating section 143 or between the second nozzle heating section 142 and the fourth nozzle heating section 144 in the Z direction. The first flow path 212 and the second flow path 252 are positioned between the first nozzle heating section 141 and the second nozzle heating section 142 in the Y direction. The nozzle flow path 230 and the nozzle 240 included in the first nozzle section 220 and the nozzle flow path 270 and the nozzle 280 included in the second nozzle section 260 are positioned between the third nozzle heating section 143 and the fourth nozzle heating section 144 in the Y direction. That is, the nozzle heating section 140 is positioned to overlap the first ejection section 121 and the second ejection section 122 as viewed from a second direction, which is a direction parallel to the molding surface 410 and is orthogonal to the first direction. In the present embodiment, the second direction is the Y direction.

The nozzle heating section 140 controls the temperature of the nozzle heating section 140 based on the detection values of temperature sensors 149 provided in the first ejection section 121 and the second ejection section 122. The temperature sensor 149 is, for example, a thermocouple. As illustrated in FIG. 3, the temperature sensor 149 is provided in the vicinity of the second nozzle heating section 142 and the third nozzle heating section 143. Note that the number and positions of the temperature sensors 149 are not limited to the above described example.

The pressing section 150 presses the plasticized material deposited on the molding surface 410. The pressing section 150 includes a first pressing section 151 and a second pressing section 152. The first pressing section 151 and the second pressing section 152 are rollers that are attached to an end portion of the material ejection section 200 on the -Z direction side and have an axis line along the X direction. The first pressing section 151 and the second pressing section 152 are attached to the end portion of the material ejection section 200 on the -Z direction side by, for example, screws 153. The first pressing section 151 and the second pressing section 152 are heated by the nozzle heating section 140 via the screws 153. The first pressing section 151 and the second pressing section 152 are arranged in the Y direction. The first pressing section 151 is positioned on the +Y direction side of the second pressing section 152. The nozzle 240 of the first ejection section 121 and the nozzle 280 of the second ejection section 122 are positioned between the first pressing section 151 and the second pressing section 152 in the Y direction. That is, the pressing section 150 is positioned to overlap the first ejection section 121 and the second ejection section 122 as viewed from the Y direction, which is the second direction. The pressing section 150 is desirably positioned to overlap all the nozzles 240 and 280 of the first ejection section 121 and the second ejection section 122 as viewed from the Y direction, which is the second direction. The pressing section 150 extends along the X direction, which is the first direction. The length of the first pressing section 151 and the second pressing section 152 in the X direction is longer than the length of a row of the nozzles 240 and 280 of the first ejection section 121 and the second ejection section 122 arranged along the X direction. The pressing section 150 is desirably a member made of stainless steel and coated with chromium nitride.

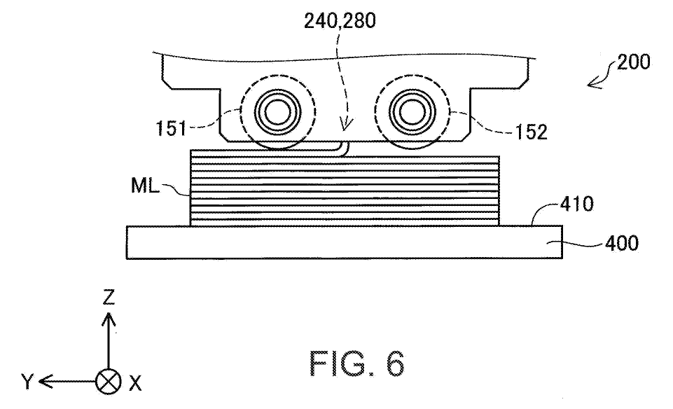

FIG. 6 is a diagram illustrating a state in which the pressing section 150 presses the plasticized material ML deposited on the molding surface 410. As illustrated in FIG. 6, in a case where the material ejection head 100 moves in the -Y direction relative to the stage 400, the first pressing section 151 positioned on the rear side in a movement direction with respect to the nozzles 240 and 280 presses the plasticized material ML deposited on the molding surface 410 downward. In a case where the material ejection head 100 moves in the +Y direction relative to the stage 400, the second pressing section 152 positioned on the rear side in the movement direction with respect to the nozzles 240 and 280 presses the plasticized material ML deposited on the molding surface 410 downward. Note that in a case where the direction in which the material ejection head 100 moves while ejecting the plasticized material ML is one direction, one pressing section 150 may be disposed behind the nozzles 240 and 280 in the direction in which the material ejection head 100 moves relative to the stage 400.

The control section 600 controls each section of the first head 101 and the second head 102 so that the plasticized material is ejected from the first ejection section 121 and the second ejection section 122 at the same time. Here, the plasticized material ejected from the first ejection section 121 and the plasticized material ejected from the second ejection section 122 are the same material. Note that the plasticized material ejected from the first ejection section 121 and the plasticized material ejected from the second ejection section 122 may be different materials.

As illustrated in FIG. 5, the material ejection head 100 further includes a first connection section 301, a second connection section 302, a third connection section 303, and a fourth connection section 304. The first connection section 301 and the second connection section 302 are columnar members, which connect a lower surface of the material supply section 110 and an upper surface of the first ejection section 121. The third connection section 303 and the fourth connection section 304 are columnar members, which connect the lower surface of the material supply section 110 and an upper surface of the second ejection section 122. In the following description, when the connection sections are referred to without distinction, they are simply referred to as connection section.

The first connection section 301 and the second connection section 302 are fixed to the first flow path forming section 210 so as to protrude from an upper surface of the first flow path forming section 210. The first connection section 301 and the second connection section 302 are columnar-shaped members having an axis line along the Z direction. The first connection section 301 and the second connection section 302 have the same shape. The size of the first connection section 301 and the size of the second connection section 302 are equal. The first connection section 301 and the second connection section 302 are arranged along the X direction. The first connection section 301 is fixed to an end portion of the first flow path forming section 210 on the -X direction side, and the second connection section 302 is fixed to an end portion of the first flow path forming section 210 on the +X direction side. Note that the first connection section 301 and the second connection section 302 are not limited to the columnar-shape, and may have a prismatic shape or the like.

The third connection section 303 and the fourth connection section 304 are fixed to the second flow path forming section 250 so as to protrude from an upper surface of the second flow path forming section 250. The third connection section 303 and the fourth connection section 304 are columnar-shaped members having an axis line along the Z direction. The third connection section 303 and the fourth connection section 304 have the same shape. The size of the third connection section 303 and the size of the fourth connection section 304 are equal. The third connection section 303 and the fourth connection section 304 are arranged along the X direction. The third connection section 303 is fixed to an end portion of the second flow path forming section 250 on the -X direction side, and the fourth connection section 304 is fixed to an end portion of the second flow path forming section 250 on the +X direction side. Note that the third connection section 303 and the fourth connection section 304 are not limited to the columnar-shape, and may have a prismatic shape or the like.

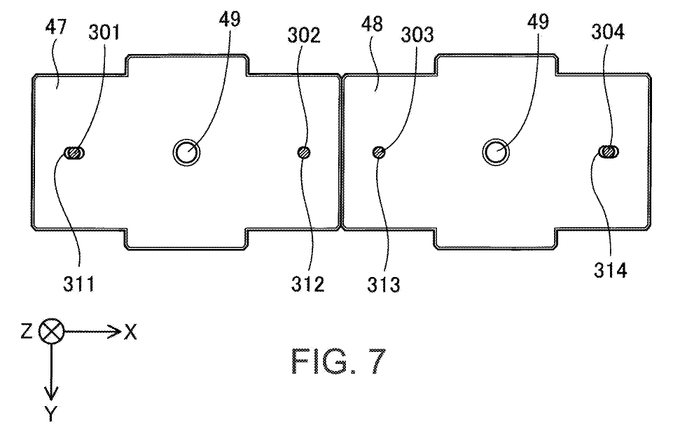

FIG. 7 is a diagram illustrating the shape of a lower surface of the first nozzle fixing section 47 and the second nozzle fixing section 48. The lower surfaces of the first nozzle fixing section 47 and the second nozzle fixing section 48 constitute a part of the lower surface of the material supply section 110. The lower surface of the first nozzle fixing section 47 has a first hole 311 into which the first connection section 301 is inserted and a second hole 312 into which the second connection section 302 is inserted. FIG. 7 illustrates a state in which the first connection section 301 and the second connection section 302 are inserted into the first hole 311 and the second hole 312, respectively. The shape of the first hole 311 as viewed in the +Z direction is a shape in which two arcs having the same radius are connected by two straight lines parallel to the X direction, that is, a so-called track shape. In other words, the size of the first hole 311 in the X direction, which is the first direction, is larger than the size of the first hole 311 in a direction intersecting the first direction and parallel to the molding surface 410. The size of the first hole 311 in the first direction is larger than the size of the first connection section 301 in the first direction. The first hole 311 and the first connection section 301 are provided such that the first connection section 301 is movable in the first direction inside the first hole 311. The shape of the second hole 312 as viewed in the +Z direction is a circular shape.

The first hole 311 and the second hole 312 are arranged along the X direction. The size of the first hole 311 in the first direction is larger than the size of the second hole 312 in the first direction. A difference in size between the first hole 311 and the first connection section 301 in the first direction is larger than a difference in size between the second hole 312 and the second connection section 302 in the first direction. As illustrated in FIG. 5, a distance L1 between the first hole 311 and the second ejection section 122 in the first direction is larger than a distance L2 between the second hole 312 and the second ejection section 122 in the first direction. Note that the shape of the second hole 312 as viewed in the +Z direction may be a polygonal shape or the like instead of a circular shape.

The lower surface of the second nozzle fixing section 48 has a third hole 313 into which the third connection section 303 is inserted and a fourth hole 314 into which the fourth connection section 304 is inserted. The shape of the third hole 313 is the same as the shape of the second hole 312. The shape of the fourth hole 314 is the same as the shape of the first hole 311. The third hole 313 and the fourth hole 314 are arranged along the X direction.

According to the first embodiment described above, the first ejection section 121 has the first flow path forming section 210 and the first nozzle section 220 having the first nozzle 241 and the second nozzle 242, and the second ejection section 122 has the second flow path forming section 250 and the second nozzle section 260 having the third nozzle 281 and the fourth nozzle 282. The first nozzle 241, the second nozzle 242, the third nozzle 281, and the fourth nozzle 282 are arranged along the first direction parallel to the molding surface 410 of the stage 400, and at least the first nozzle 241, the second nozzle 242, the third nozzle 281, and the fourth nozzle 282 of the first nozzle section 220 and the second nozzle section 260 are formed in the second member 292, which is a single member. Since the first nozzle 241, the second nozzle 242, the third nozzle 281, and the fourth nozzle 282 are formed in a single member so as to be arranged along the first direction, it is possible to reduce the influence of the deformation of the first ejection section 121 and the second ejection section 122 due to a temperature change on the distance between the nozzles in the first direction. Therefore, the molding accuracy can be improved.

In the present embodiment, the first nozzle section 220 has the first nozzle flow path 231 and the second nozzle flow path 232, the second nozzle section 260 has the third nozzle flow path 271 and the fourth nozzle flow path 272, and the first nozzle flow path 231, the second nozzle flow path 232, the third nozzle flow path 271, and the fourth nozzle flow path 272 are formed in the second member 292, which is a single member. Therefore, compared to a case where the first nozzle flow path 231, the second nozzle flow path 232, the third nozzle flow path 271, and the fourth nozzle flow path 272 are not formed in the second member 292, it is possible to further reduce the influence of the deformation of the first ejection section 121 and the second ejection section 122 due to the temperature change on the distance between the nozzles in the first direction. Therefore, the molding accuracy can be further improved.

In the present embodiment, the material ejection head 100 includes the first connection section 301 that connects the lower surface of the material supply section 110 and the upper surface of the first ejection section 121, the lower surface of the material supply section 110 has the first hole 311 into which the first connection section 301 is inserted, and the size of the first hole 311 in the first direction is larger than the size of the first hole 311 in the direction intersecting the first direction and parallel to the molding surface 410. The first ejection section 121 and the second ejection section 122 tend to be greatly deformed in the first direction due to the temperature change. In the present embodiment, since the first connection section 301 is movable in the first direction inside the first hole 311, at least a part of the deformation of the first ejection section 121 and the second ejection section 122 in the first direction can be absorbed by the first connection section 301 and the first hole 311. Therefore, it is possible to reduce the influence of the deformation of the first ejection section 121 and the second ejection section 122 due to the temperature change on the distance between the nozzles in the first direction. Therefore, the molding accuracy can be improved.

In the present embodiment, the material ejection head 100 further includes the second connection section 302 that connects the lower surface of the material supply section 110 and the upper surface of the first ejection section 121, the lower surface of the material supply section 110 has the second hole 312 into which the second connection section 302 is inserted, the distance L1 between the first hole 311 and the second ejection section 122 in the first direction is larger than the distance L2 between the second hole 312 and the second ejection section 122 in the first direction, and the size of the first hole 311 in the first direction is larger than the size of the second hole 312 in the first direction. The positional deviation between the material ejection section 200 and the material supply section 110 in the first direction due to the deformation of the first ejection section 121 and the second ejection section 122 is larger at an end portion of the material ejection section 200 than at a central portion of the material ejection section 200 in the first direction. That is, the positional deviation between the material ejection section 200 and the material supply section 110 in the first direction is larger in the first connection section 301 than in the second connection section 302. In other words, the positional deviation between the first ejection section 121 and the material supply section 110 in the first direction is larger in the first hole 311 than in the second hole 312. In the present embodiment, since the size of the first hole 311 in the first direction is larger than the size of the second hole 312 in the first direction, the influence of the deformation of the first ejection section 121 and the second ejection section 122 due to the temperature change on the distance between the nozzles in the first direction can be further reduced. Therefore, the molding accuracy can be further improved.

In the present embodiment, the material supply section 110 includes the plasticizing section 30 that plasticizes the material, and the first supply port 211 and the second supply port 251 communicate with the plasticizing section 30. In a case where the first ejection section 121 and the second ejection section 122 eject the high-temperature plasticized material plasticized by the plasticizing section 30, the deformation of the first ejection section 121 and the second ejection section 122 due to thermal expansion increases. In the present embodiment, even in a case where the high-temperature plasticized material is ejected, it is possible to reduce the influence of the deformation of the first ejection section 121 and the second ejection section 122 due to the temperature change on the distance between the nozzles in the first direction. Therefore, the molding accuracy can be improved.

In the present embodiment, the material ejection head 100 further includes the nozzle heating section 140 that heats the first ejection section 121 and the second ejection section 122, and the nozzle heating section 140 extends along the first direction and is positioned to overlap the first ejection section 121 and the second ejection section 122 as viewed from a second direction, which is a direction parallel to the molding surface 410 and is orthogonal to the first direction. Therefore, the plasticized material inside the first ejection section 121 and the second ejection section 122 can be kept at a high temperature with a simple configuration.

In the present embodiment, the material ejection head 100 further includes the pressing section 150 that presses the material deposited on the molding surface 410, and the pressing section 150 extends along the first direction and is positioned to overlap the first ejection section 121 and the second ejection section 122 when viewed from the second direction that is a direction parallel to the molding surface 410 and orthogonal to the first direction. Therefore, the material ejected from the first ejection section 121 and the second ejection section 122 can be pressed with a simple configuration. The pressing section 150 presses the material deposited on the molding surface 410, and thus, it is possible to reduce the possibility that a void is generated inside the deposited material.

### B. Second Embodiment

A second embodiment is different from the first embodiment in the connection section and the hole into which the connection section is inserted. The configuration of each part of the three dimensional molding device 10 other than the connection section and the hole into which the connection section is inserted is the same as that of the first embodiment.

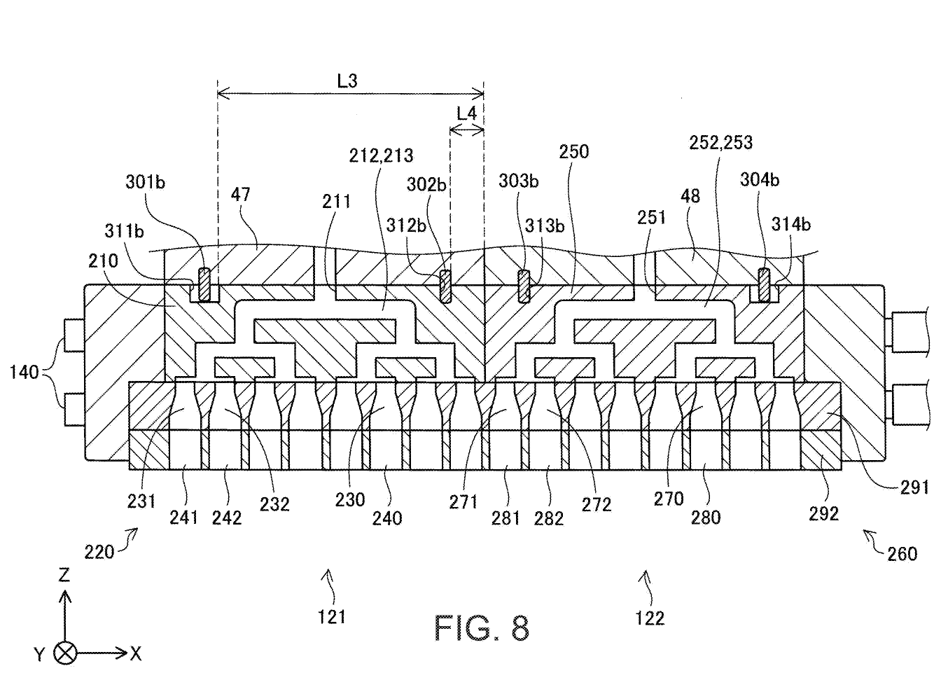

FIG. 8 is a cross-sectional view taken along line V-V illustrated in FIG. 3 in the second embodiment. In the second embodiment, a first connection section 301b and a second connection section 302b are fixed to the first nozzle fixing section 47 so as to protrude from the lower surface of the first nozzle fixing section 47. The first connection section 301b and the second connection section 302b are arranged along the X direction. The first connection section 301b is fixed to an end portion of the first nozzle fixing section 47 on the -X direction side, and the second connection section 302b is fixed to an end portion of the first nozzle fixing section 47 on the +X direction side. A third connection section 303b and a fourth connection section 304b are fixed to the second nozzle fixing section 48 so as to protrude from the lower surface of the second nozzle fixing section 48. The third connection section 303b and the fourth connection section 304b are arranged along the X direction. The third connection section 303b is fixed to an end portion of the second nozzle fixing section 48 on the -X direction side, and the fourth connection section 304b is fixed to an end portion of the second nozzle fixing section 48 on the +X direction side. The shape and size of each connection section are the same as those in the first embodiment.

In the second embodiment, a first hole 311b and a second hole 312b are formed on the upper surface of the first ejection section 121. In other words, the upper surface of the first ejection section 121 has the first hole 311b and the second hole 312b. The first hole 311b and the second hole 312b are arranged along the X direction. The shapes of the first hole 311b and the second hole 312b are the same as those in the first embodiment. That is, the size of the first hole 311b in the first direction is larger than the size of the first hole 311b in a direction intersecting the first direction and parallel to the molding surface 410. The first hole 311b and the first connection section 301b are provided such that the first connection section 301b is movable in the first direction inside the first hole 311b. The size of the first hole 311b in the first direction is larger than the size of the second hole 312b in the first direction. A difference in size between the first hole 311b and the first connection section 301b in the first direction is larger than a difference in size between the second hole 312b and the second connection section 302b in the first direction. A distance L3 between the first hole 311b and the second ejection section 122 in the first direction is larger than a distance L4 between the second hole 312b and the second ejection section 122 in the first direction.

A third hole 313b and a fourth hole 314b are formed on the upper surface of the second ejection section 122. In other words, the upper surface of the second ejection section 122 has the third hole 313b and the fourth hole 314b. The third hole 313b and the fourth hole 314b are arranged along the X direction. The shapes of the third hole 313b and the fourth hole 314b are the same as those in the first embodiment.

According to the second embodiment described above, the material ejection head 100 includes the first connection section 301b that connects the lower surface of the material supply section 110 and the upper surface of the first ejection section 121, the upper surface of the first ejection section 121 has the first hole 311b into which the first connection section 301b is inserted, and the size of the first hole 311b in the first direction is larger than the size of the first hole 311b in the direction intersecting the first direction and parallel to the molding surface 410. Therefore, similarly to the first embodiment, it is possible to reduce the influence of the deformation of the first ejection section 121 and the second ejection section 122 due to the temperature change on the distance between the nozzles in the first direction.

In the present embodiment, the material ejection head 100 further includes the second connection section 302b that connects the lower surface of the material supply section 110 and the upper surface of the first ejection section 121, the upper surface of the first ejection section 121 has the second hole 312b into which the second connection section 302b is inserted, the distance L3 between the first hole 311b and the second ejection section 122 in the first direction is larger than the distance L4 between the second hole 312b and the second ejection section 122 in the first direction, and the size of the first hole 311b in the first direction is larger than the size of the second hole 312b in the first direction. Therefore, similarly to the first embodiment, it is possible to further reduce the influence of the deformation of the first ejection section 121 and the second ejection section 122 due to the temperature change on the distance between the nozzles in the first direction.

### C. Third Embodiment

A third embodiment is different from the first embodiment in the connection section and the hole into which the connection section is inserted. The configuration of each part of the three dimensional molding device 10 other than the connection section and the hole into which the connection section is inserted is the same as that of the first embodiment.

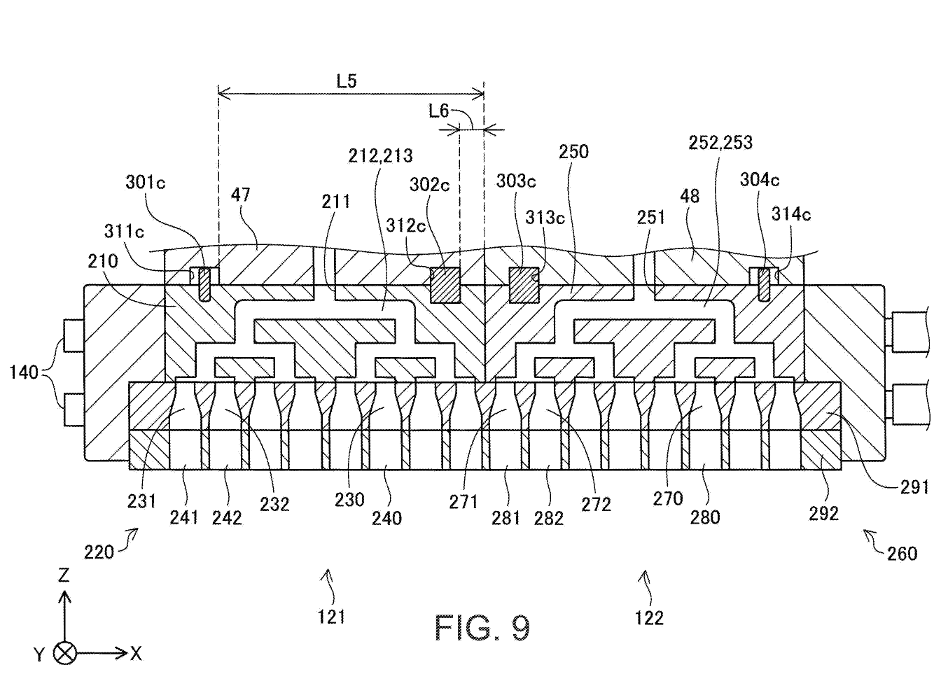

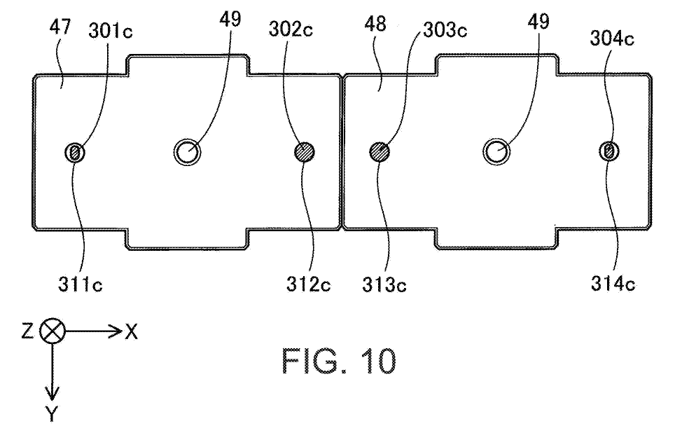

FIG. 9 is a cross-sectional view taken along line V-V illustrated in FIG. 3 in the third embodiment. FIG. 10 is a diagram illustrating the shape of the lower surface of the first nozzle fixing section 47 and the second nozzle fixing section 48 in the third embodiment. A first connection section 301c and a second connection section 302c are fixed to the first flow path forming section 210 so as to protrude from the upper surface of the first flow path forming section 210. The first connection section 301c is an elliptic columnar-shaped member having an axis line along the Z direction. The size of the first connection section 301c in the X direction, which is the first direction, is smaller than the size of the first connection section 301c in a direction, which intersects the first direction and parallel to the molding surface 410. The second connection section 302c is a columnar-shaped member having an axis line along the Z direction. The size of the first connection section 301c in the first direction is smaller than the size of the second connection section 302c in the first direction. Note that the first connection section 301 may be a columnar member having a track-shaped cross section horizontal to the molding surface 410.

A third connection section 303c and a fourth connection section 304c are fixed to the second flow path forming section 250 so as to protrude from the upper surface of the second flow path forming section 250. The shape of the third connection section 303c is the same as the shape of the second connection section 302c. The shape of the fourth connection section 304c is the same as the shape of the first connection section 301c.

The lower surface of the first nozzle fixing section 47 has a first hole 311c into which the first connection section 301c is inserted and a second hole 312c into which the second connection section 302c is inserted. FIG. 10 illustrates a state in which the first connection section 301c and the second connection section 302c are inserted into the first hole 311c and the second hole 312c, respectively. The first hole 311c and the second hole 312c are arranged along the X direction. The shapes of the first hole 311c and the second hole 312c as viewed in the +Z direction are circular shapes. The size of the first hole 311c and the size of the second hole 312c are equal. The size of the first hole 311c in the first direction is larger than the size of the first connection section 301c in the first direction. The first hole 311c and the first connection section 301c are provided such that the first connection section 301c is movable in the first direction inside the first hole 311c. A difference in size between the first hole 311c and the first connection section 301c in the first direction is larger than a difference in size between the second hole 312c and the second connection section 302c in the first direction. As illustrated in FIG. 9, a distance L5 between the first hole 311c and the second ejection section 122 in the first direction is larger than a distance L6 between the second hole 312c and the second ejection section 122 in the first direction. Note that the shape of the first hole 311c and the second hole 312c as viewed in the +Z direction is not limited to a circular shape, and may be a polygonal shape or the like.

The lower surface of the second nozzle fixing section 48 has a third hole 313c into which the third connection section 303c is inserted and a fourth hole 314c into which the fourth connection section 304c is inserted. The shape of the third hole 313c is the same as the shape of the second hole 312c. The shape of the fourth hole 314c is the same as the shape of the first hole 311c. The third hole 313c and the fourth hole 314c are arranged along the X direction.

According to the third embodiment described above, the material ejection head 100 includes the first connection section 301c, which is a columnar member, that connects the lower surface of the material supply section 110 and the upper surface of the first ejection section 121, the lower surface of the material supply section 110 has the first hole 311c into which the first connection section 301c is inserted, and the size of the first connection section 301c in the first direction is smaller than the size of the first connection section 301c in the direction intersecting the first direction and parallel to the molding surface 410. In the present embodiment, since the first connection section 301c is movable in the first direction inside the first hole 311c, at least a part of the deformation of the first ejection section 121 and the second ejection section 122 in the first direction can be absorbed by the first connection section 301c and the first hole 311c. Therefore, it is possible to reduce the influence of the deformation of the first ejection section 121 and the second ejection section 122 due to the temperature change on the distance between the nozzles in the first direction. Therefore, the molding accuracy can be improved.

In the present embodiment, the material ejection head 100 further includes the second connection section 302c, which is a columnar member, connecting the lower surface of the material supply section 110 and the upper surface of the first ejection section 121, the lower surface of the material supply section 110 has the second hole 312c into which the second connection section 302c is inserted, the distance L5 between the first hole 311c and the second ejection section 122 in the first direction is larger than the distance L6 between the second hole 312c and the second ejection section 122 in the first direction, and the size of the first connection section 301c in the first direction is smaller than the size of the second connection section 302c in the first direction. As described in the first embodiment, the positional deviation between the material ejection section 200 and the material supply section 110 in the first direction due to the deformation of the first ejection section 121 and the second ejection section 122 is larger in the first connection section 301c than in the second connection section 302c. The positional deviation between the first ejection section 121 and the material supply section 110 in the first direction due to the deformation of the first ejection section 121 and the second ejection section 122 is larger in the first hole 311c than in the second hole 312c. In the present embodiment, since the size of the first connection section 301c in the first direction is smaller than the size of the second connection section 302c in the first direction, it is possible to further reduce the influence of the deformation of the first ejection section 121 and the second ejection section 122 due to the temperature change on the distances between the nozzles in the first direction. Therefore, the molding accuracy can be further improved.

### D. Fourth Embodiment

A fourth embodiment is different from the third embodiment in the connection section and the hole into which the connection section is inserted. The configuration of each part of the three dimensional molding device 10 other than the connection section and the hole into which the connection section is inserted is the same as that of the third embodiment.

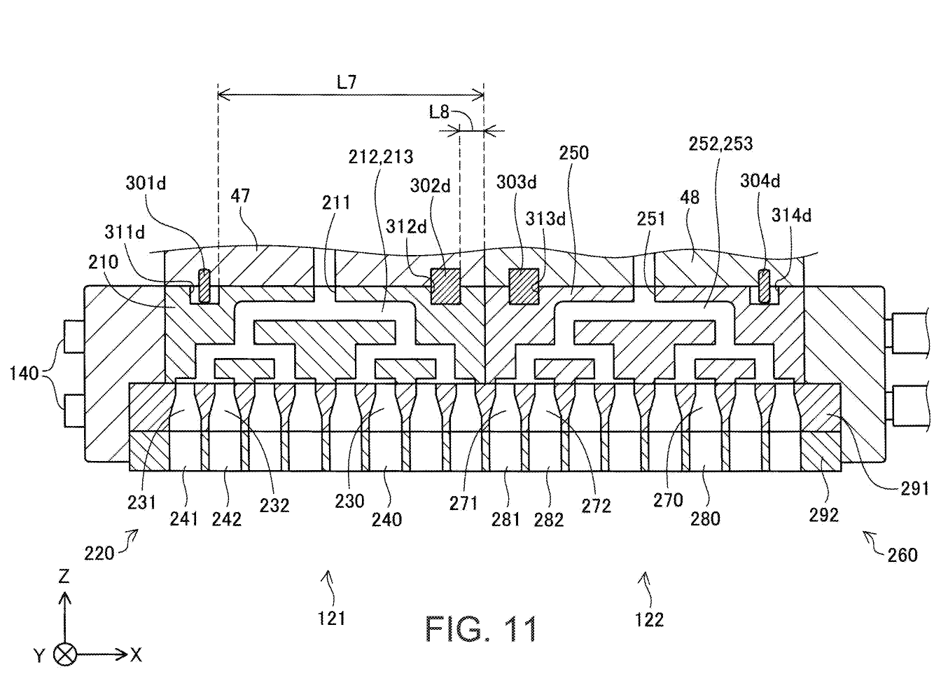

FIG. 11 is a cross-sectional view taken along line V-V illustrated in FIG. 3 in the fourth embodiment. In the fourth preferred embodiment, a first connection section 301d and a second connection section 302d are fixed to the first nozzle fixing section 47 so as to protrude from the lower surface of the first nozzle fixing section 47. The first connection section 301d and the second connection section 302d are arranged along the X direction. The first connection section 301d is fixed to the end portion of the first nozzle fixing section 47 on the -X direction side, and the second connection section 302d is fixed to an end portion of the first nozzle fixing section 47 on the +X direction side. A third connection section 303d and a fourth connection section 304d are fixed to the second nozzle fixing section 48 so as to protrude from the lower surface of the second nozzle fixing section 48. The third connection section 303d and the fourth connection section 304d are arranged along the X direction. The third connection section 303d is fixed to the end portion of the second nozzle fixing section 48 on the -X direction side, and the fourth connection section 304d is fixed to an end portion of the second nozzle fixing section 48 on the +X direction side. The shape and size of each connection section are the same as those in the third embodiment. That is, the size of the first connection section 301d in the X direction, which is the first direction, is smaller than the size of the first connection section 301d in a direction, which intersects the first direction and is parallel to the molding surface 410. The size of the first connection section 301d in the first direction is smaller than the size of the second connection section 302d in the first direction.

In the fourth embodiment, a first hole 311d and a second hole 312d are formed on the upper surface of the first ejection section 121. In other words, the upper surface of the first ejection section 121 has the first hole 311d and the second hole 312d. The first hole 311d and the second hole 312d are arranged along the X direction. The shapes of the first hole 311d and the second hole 312d are the same as those in the third embodiment. The first hole 311d and the first connection section 301d are provided such that the first connection section 301d is movable in the first direction inside the first hole 311d. A difference in size between the first hole 311d and the first connection section 301d in the first direction is larger than a difference in size between the second hole 312d and the second connection section 302d in the first direction. A distance L7 between the first hole 311d and the second ejection section 122 in the first direction is larger than a length L8 between the second hole 312d and the second ejection section 122 in the first direction.

The lower surface of the second nozzle fixing section 48 has a third hole 313d into which the third connection section 303d is inserted and a fourth hole 314d into which the fourth connection section 304d is inserted. The shape of the third hole 313d is the same as the shape of the second hole 312d. The shape of the fourth hole 314d is the same as the shape of the first hole 311d. The third hole 313d and the fourth hole 314d are arranged along the X direction.

According to the fourth embodiment described above, the material ejection head 100 includes the first connection section 301d, which is a columnar member, connecting the lower surface of the material supply section 110 and the upper surface of the first ejection section 121, the upper surface of the first ejection section 121 has the first hole 311d into which the first connection section 301d is inserted, and the size of the first connection section 301d in the first direction is smaller than the size of the first connection section 301d in the direction intersecting the first direction and parallel to the molding surface 410. Therefore, similarly to the third embodiment, it is possible to reduce the influence of the deformation of the first ejection section 121 and the second ejection section 122 due to the temperature change on the distance between the nozzles in the first direction.

In the present embodiment, the material ejection head 100 further includes the second connection section 302d, which is a columnar member, connecting the lower surface of the material supply section 110 and the upper surface of the first ejection section 121, the upper surface of the first ejection section 121 has the second hole 312d into which the second connection section 302d is inserted, the distance L7 between the first hole 311d and the second ejection section 122 in the first direction is larger than the distance L8 between the second hole 312d and the second ejection section 122 in the first direction, and the size of the first connection section 301d in the first direction is smaller than the size of the second connection section 302d in the first direction. Therefore, similarly to the third embodiment, it is possible to further reduce the influence of the deformation of the first ejection section 121 and the second ejection section 122 due to the temperature change on the distance between the nozzles in the first direction.

### E. Fifth Embodiment

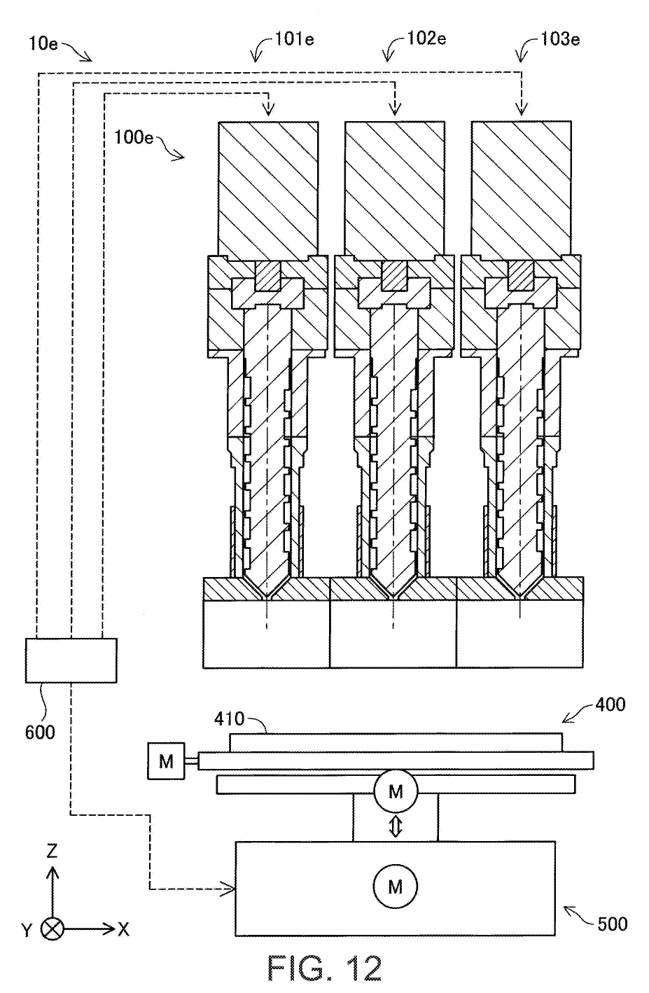

FIG. 12 is an explanatory diagram illustrating a schematic configuration of a three dimensional molding device 10e according to a fifth embodiment. In the fifth embodiment, a material ejection head 100e includes a first head 101e, a second head 102e, and a third head 103e. The configuration of each part of the three dimensional molding device 10e other than the material ejection head 100e is the same as that of the first embodiment. Note that in FIG. 12, the material supply section 110, the communication path 21, and the cooling section 70 are not illustrated.

The first head 101e and the second head 102e are different from the first head 101 and the second head 102 in the first embodiment in the connection section, the hole into which the connection section is inserted, a first member 291e, and a second member 292e. The configurations of the sections of the first head 101e and the second head 102e other than the members described above are the same as those of the first head 101 and the second head 102 in the first embodiment. The structure of the third head 103e is the same as the structure of the first head 101e except for the first member 291e and the second member 292e. The first head 101e, the second head 102e, and the third head 103e are provided side by side in this order in the horizontal direction. In the present embodiment, the first head 101e, the second head 102e, and the third head 103e are provided side by side in this order in the X direction.

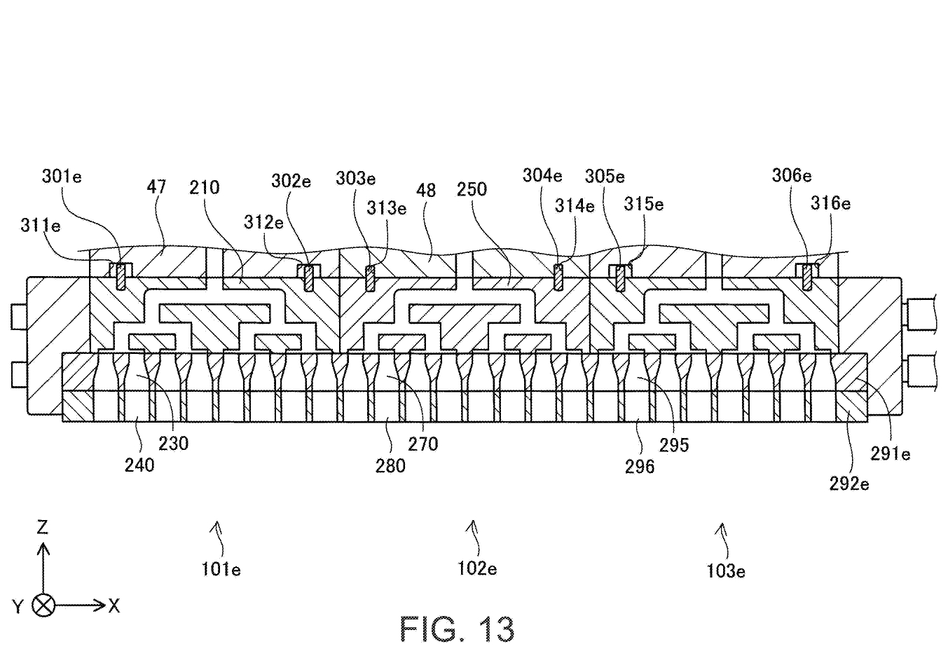

FIG. 13 is a cross-sectional view taken along the line V-V illustrated in FIG. 3 in the fifth embodiment. A first connection section 301e and a second connection section 302e are fixed to the first flow path forming section 210 so as to protrude from the upper surface of the first flow path forming section 210. The shape and size of the first connection section 301e are the same as those of the first connection section 301 in the first embodiment. The shape and size of the second connection section 302e are the same as those of the second connection section 302 in the first embodiment.

A third connection section 303e and a fourth connection section 304e are fixed to the second flow path forming section 250 so as to protrude from the upper surface of the second flow path forming section 250. The shape and size of the third connection section 303e are the same as those of the third connection section 303 in the first embodiment. The shape and size of the fourth connection section 304e are the same as those of the second connection section 302 in the first embodiment.

The third head 103e includes a fifth connection section 305e and a sixth connection section 306e. The fifth connection section 305e and the sixth connection section 306e are columnar members, which connect the lower surface of the material supply section 110 of the third head 103e and an upper surface of the ejection section 120 of the third head 103e. The fifth connection section 305e and the sixth connection section 306e are arranged along the X direction. The fifth connection section 305e is fixed to an end portion on the -X direction side of the flow path forming section of the third head 103e, and the sixth connection section 306e is fixed to an end portion on the +X direction side of the flow path forming section of the third head 103e. The shape and size of the fifth connection section 305e are the same as those of the second connection section 302e. The shape and size of the sixth connection section 306e are the same as those of the first connection section 301e.

The lower surface of the first nozzle fixing section 47 has a first hole 311e into which the first connection section 301e is inserted and a second hole 312e into which the second connection section 302e is inserted. The shape and size of the first hole 311e are the same as those of the first hole 311 in the first embodiment. The shape and size of the second hole 312e are the same as those of the first hole 311 in the first embodiment. The first hole 311e and the first connection section 301e are provided such that the first connection section 301e is movable in the first direction inside the first hole 311e. The second hole 312e and the second connection section 302e are provided such that the second connection section 302e is movable in the first direction inside the second hole 312e.

The lower surface of the second nozzle fixing section 48 has a third hole 313e into which the third connection section 303e is inserted and a fourth hole 314e into which the fourth connection section 304e is inserted. The shape and size of the third hole 313e are the same as those of the second hole 312 in the first embodiment. The shape and size of the fourth hole 314e are the same as those of the second hole 312 in the first embodiment.

A lower surface of the nozzle fixing section 46 of the third head 103e has a fifth hole 315e into which the fifth connection section 305e is inserted and a sixth hole 316e into which the sixth connection section 306e is inserted. The shape of the fifth hole 315e is the same as the shape of the second hole 312e. The shape of the sixth hole 316e is the same as the shape of the first hole 311e. The fifth hole 315e and the fifth connection section 305e are provided such that the fifth connection section 305e is movable in the first direction inside the fifth hole 315e. The sixth hole 316e and the sixth connection section 306e are provided such that the sixth connection section 306e is movable in the first direction inside the sixth hole 316e.

As illustrated in FIG. 13, in the fifth embodiment, the first member 291e is formed with each nozzle flow path 230 of the first head 101e, each nozzle flow path 270 of the second head 102e, and each nozzle flow path 295 of the third head 103e. The second member 292e is formed with each nozzle flow path 230 of the first head 101e, each nozzle flow path 270 of the second head 102e, each nozzle flow path 295 of the third head 103e, each nozzle 240 of the first head 101e, each nozzle 280 of the second head 102e, and each nozzle 296 of the third head 103e. All the nozzles 240, 280, and 296 included in the first head 101e, the second head 102e, and the third head 103e are arranged along the first direction.

According to the fifth embodiment described above, since the nozzles 240 included in the first head 101e, the nozzles 280 included in the second head 102e, and the nozzles 296 included in the third head 103e are formed side by side along the first direction in a single member, it is possible to reduce the influence of the deformation of the ejection section 120 due to the temperature change on the distances between the nozzles in the first direction. Therefore, the molding accuracy can be improved.

In the present embodiment, the size of the first hole 311e in the first direction is larger than the size of the third hole 313e in the first direction. The size of the second hole 312e in the first direction is larger than the size of the third hole 313e in the first direction. As described above, the positional deviation between the material ejection section 200 and the material supply section 110 in the first direction due to the deformation of the ejection section 120 is larger at the end portion of the material ejection section 200 than at the central portion of the material ejection section 200 in the first direction. Therefore, in the present embodiment, it is possible to further reduce the influence of the deformation of the ejection section 120 due to the temperature change on the distance between the nozzles in the first direction. Therefore, the molding accuracy can be further improved.

### F. Other Embodiment

(F-1) In the above embodiment, the first member 291 and the second member 292 may be formed as a single member.

(F-2) In the above embodiment, the first nozzle flow path 231, the second nozzle flow path 232, the third nozzle flow path 271, the fourth nozzle flow path 272, the first nozzle 241, the second nozzle 242, the third nozzle 281, and the fourth nozzle 282 are formed in the second member 292. In contrast, the first nozzle flow path 231, the second nozzle flow path 232, the third nozzle flow path 271, and the fourth nozzle flow path 272 may not be formed in the second member 292. That is, only the first nozzle 241, the second nozzle 242, the third nozzle 281, and the fourth nozzle 282 may be formed in the second member 292, which is a single member.

(F-3) In the above embodiment, the material ejection head 100 has the second connection section 302 and the second hole 312. In contrast, the material ejection head 100 may not have both the second connection section 302 and the second hole 312.

(F-4) In the above embodiment, the material ejection section 200 has the ejection adjusting section 130. In contrast, the material ejection section 200 may not have the ejection adjusting section 130.

(F-5) In the above embodiment, the material ejection section 200 has the nozzle heating section 140. In contrast, the material ejection section 200 may not have the nozzle heating section 140.

(F-6) In the above embodiment, the material ejection section 200 has the pressing section 150. In contrast, the material ejection section 200 may not have the pressing section 150.

(F-7) In the above embodiment, the material supply section 110 has the plasticizing section 30. In contrast, the material supply section 110 may not have the plasticizing section 30.

(F-8) In the above embodiment, the first nozzle section 220 has eight nozzles 240. The second nozzle section 260 has eight nozzles 280. In contrast, the first nozzle section 220 may have two or more and seven or less nozzles 240, or nine or more nozzles 240. The second nozzle section 260 may have two or more and seven or less nozzles 280, or nine or more nozzles 280. The number of nozzles 240 included in the first nozzle section 220 and the number of nozzles 280 included in the second nozzle section 260 may be different from each other.

(F-9) In the first embodiment to fourth embodiment, the material ejection head 100 includes two heads provided side by side in the first direction. In the fifth embodiment, the material ejection head 100e includes three heads provided side by side in the first direction. In contrast, the material ejection head 100 may include four or more heads provided side by side in the first direction. In this case, all the nozzles included in each head are arranged along the first direction and are formed in a single member.

(F-10) In the above embodiment, the screw 50 has a shaft shape centered on the rotation axis AX2. In contrast, the screw 50 may be a flat screw having a substantially columnar shape in which the height in the direction along the central axis is smaller than the diameter, and having a groove forming surface in which a spiral groove is formed.

(F-11) In the above embodiments, in the first embodiment, the second embodiment, and the fifth embodiment, the size of the first connection section 301 and the size of the second connection section 302 are equal to each other. In contrast, the size of the first connection section 301 and the size of the second connection section 302 may be different from each other.

(F-12) In the above embodiments, in the third embodiment and the fourth embodiment, the size of the first hole 311 and the size of the second hole 312 are equal. In contrast, the size of the first hole 311 and the size of the second hole 312 may be different from each other.

(F-13) In the above embodiment, the first flow path 212 has the first branch flow path 213. In contrast, the first nozzle section 220 may have the first branch flow path 213.

(F-14) In the above embodiment, the second flow path 252 has the second branch flow path 253. In contrast, the second nozzle section 260 may have the second branch flow path 253.

(F-15) The present disclosure may be realized in the form of the material ejection head 100.

### G. Other Forms

The present disclosure is not limited to the embodiments described above, but can be realized in various forms without departing from the scope of the present disclosure. For example, the present disclosure can also be realized by the following forms. The technical features in the above embodiments that correspond to the technical features in each aspect described below can be replaced or combined as appropriate to solve some or all of the issues of this disclosure or to achieve some or all of the effects of this disclosure. Unless the technical features are described as essential in the present specification, the technical features can be appropriately deleted.

1. According to a first aspect of the present disclosure, a three dimensional molding device is provided.

This three dimensional molding device includes a material supply section configured to supply a material; a first ejection section and a second ejection section that communicate with the material supply section and that are configured to eject the material; and a stage having a molding surface on which the material ejected from the first ejection section and the second ejection section are deposited, wherein the first ejection section has a first flow path forming section having a first supply port that communicates with the material supply section and to which the material is supplied, and a first flow path that communicates with the first supply port and a first nozzle section that communicates with the first flow path and that has a first nozzle and a second nozzle, which are configured to eject the material, the second ejection section has a second flow path forming section having a second supply port that communicates with the material supply section and to which the material is supplied, and a second flow path that communicates with the second supply port and a second nozzle section that communicates with the second flow path and that has a third nozzle and a fourth nozzle that are configured to eject the material, the first nozzle, the second nozzle, the third nozzle, and the fourth nozzle are arranged along a first direction parallel to the molding surface, and among the first nozzle section and the second nozzle section, at least the first nozzle, the second nozzle, the third nozzle, and the fourth nozzle are formed in a single member.

According to such an aspect, it is possible to reduce the influence of the deformation of the first ejection section and the second ejection section due to the temperature change on the distance between the nozzles in the first direction. Therefore, the molding accuracy can be improved.

2. The above aspect may be such that the first flow path has a first branch flow path, the first nozzle section has a first nozzle flow path that communicates with the first branch flow path and the first nozzle and a second nozzle flow path that communicates with the first branch flow path and the second nozzle, the second flow path has a second branch flow path, the second nozzle section has a third nozzle flow path that communicates with the second branch flow path and the third nozzle and a fourth nozzle flow path that communicates with the second branch flow path and the fourth nozzle, and the first nozzle flow path, the second nozzle flow path, the third nozzle flow path, and the fourth nozzle flow path are formed in the single member.

According to such an aspect, as compared to a case where the first nozzle flow path, the second nozzle flow path, the third nozzle flow path, and the fourth nozzle flow path are not formed in the single member, it is possible to further reduce the influence of the deformation of the first ejection section and the second ejection section due to the temperature change on the distance between the nozzles in the first direction.

3. The above aspect may further includes a first connection section that is a columnar member configured to connect a lower surface of the material supply section and an upper surface of the first ejection section, wherein the lower surface of the material supply section or the upper surface of the first ejection section has a first hole into which the first connection section is inserted and a size of the first hole in the first direction is larger than a size of the first hole in a direction intersecting the first direction and parallel to the molding surface.

According to such an aspect, since the first connection section is movable in the first direction inside the first hole, at least a part of the deformation of the first ejection section and the second ejection section in the first direction can be absorbed by the first connection section and the first hole. Therefore, it is possible to reduce the influence of the deformation of the first ejection section and the second ejection section due to the temperature change on the distance between the nozzles in the first direction.

4. The above aspect may further includes a second connection section that is a columnar member configured to connect the lower surface of the material supply section and the upper surface of the first ejection section, wherein the lower surface of the material supply section or the upper surface of the first ejection section has a second hole into which the second connection section is inserted, a distance between the first hole and the second ejection section in the first direction is larger than a distance between the second hole and the second ejection section in the first direction, and the size of the first hole in the first direction is larger than a size of the second hole in the first direction.

The positional deviation between the material ejection section and the material supply section in the first direction due to the deformation of the first ejection section and the second ejection section is larger in the vicinity of the first connection section than in the vicinity of the second connection section. According to the above aspect, it is possible to further reduce the influence of the deformation of the first ejection section and the second ejection section due to the temperature change on the distance between the nozzles in the first direction.

5. The above aspect may further includes a first connection section that is a columnar member configured to connect a lower surface of the material supply section and an upper surface of the first ejection section, wherein the lower surface of the material supply section or the upper surface of the first ejection section has a first hole into which the first connection section is inserted and a size of the first connection section in the first direction is smaller than a size of the first connection section in a direction that intersects the first direction and that is parallel to the molding surface.

According to such an aspect, since the first connection section is movable in the first direction inside the first hole, at least a part of the deformation of the first ejection section and the second ejection section in the first direction can be absorbed by the first connection section and the first hole. Therefore, it is possible to reduce the influence of the deformation of the first ejection section and the second ejection section due to the temperature change on the distance between the nozzles in the first direction.

6. The above aspect may further includes a second connection section that is a columnar member configured to connect the lower surface of the material supply section and the upper surface of the first ejection section, wherein the lower surface of the material supply section or the upper surface of the first ejection section has a second hole into which the second connection section is inserted, a distance between the first hole and the second ejection section in the first direction is larger than a distance between the second hole and the second ejection section in the first direction, and the size of the first connection section in the first direction is smaller than a size of the second connection section in the first direction.

The positional deviation between the material ejection section and the material supply section in the first direction due to the deformation of the first ejection section and the second ejection section is larger in the vicinity of the first connection section than in the vicinity of the second connection section. According to the above aspect, it is possible to further reduce the influence of the deformation of the first ejection section and the second ejection section due to the temperature change on the distance between the nozzles in the first direction.

7. The above aspect may be such that the material supply section includes a plasticizing section configured to plasticize the material and the first supply port and the second supply port communicate with the plasticizing section.

According to such an aspect, even in a case where the high-temperature plasticized material plasticized by the plasticizing section is ejected, it is possible to reduce the influence of the deformation of the first ejection section and the second ejection section due to the temperature change on the distance between the nozzles in the first direction.

8. The above aspect may further includes a nozzle heating section configured to heat the first ejection section and the second ejection section, wherein the nozzle heating section extends along the first direction and the nozzle heating section is positioned to overlap the first ejection section and the second ejection section as viewed from a second direction, which is a direction parallel to the molding surface and is orthogonal to the first direction.

According to such an aspect, the plasticized material inside the first ejection section and the second ejection section can be kept at a high temperature with a simple configuration.

9. The above aspect may further includes a pressing section configured to press the material deposited on the molding surface, wherein the pressing section extends along the first direction and the pressing section is positioned to overlap the first ejection section and the second ejection section as viewed from a second direction, which is a direction parallel to the molding surface and is orthogonal to the first direction.

According to such an aspect, the material ejected from the first ejection section and the second ejection section can be pressed with a simple configuration. It is possible to reduce the possibility that a void is generated inside the deposited material on the molding surface.

10. According to a second aspect of the present disclosure, a material ejection head that ejects a material to a stage is provided. This material ejection head includes a first ejection section and a second ejection section configured to eject the material, wherein the first ejection section has a first flow path forming section having a first supply port to which the material is supplied and a first flow path communicating with the first supply port and a first nozzle section that communicates with the first flow path and that has a first nozzle and a second nozzle, which are configured to eject the material, the second ejection section has a second flow path forming section having a second supply port to which the material is supplied and a second flow path communicating with the second supply port and a second nozzle section that communicates with the second flow path and that has a third nozzle and a fourth nozzle that are configured to eject the material, the first nozzle, the second nozzle, the third nozzle, and the fourth nozzle are arranged along a first direction parallel to a surface of the stage, and among the first nozzle section and the second nozzle section, at least the first nozzle, the second nozzle, the third nozzle, and the fourth nozzle are formed in a single member.

According to such an aspect, it is possible to reduce the influence of the deformation of the first ejection section and the second ejection section due to the temperature change on the distance between the nozzles in the first direction. Therefore, the molding accuracy can be improved.

What is claimed is:

1. A three dimensional molding device comprising:
a material supply section configured to supply a material;
a first ejection section and a second ejection section that communicate with the material supply section and that are configured to eject the material; and
a stage having a molding surface on which the material ejected from the first ejection section and the second ejection section are deposited, wherein
the first ejection section has
a first flow path forming section having a first supply port that communicates with the material supply section and to which the material is supplied, and a first flow path that communicates with the first supply port and
a first nozzle section that communicates with the first flow path and that has a first nozzle and a second nozzle that are configured to eject the material,
the second ejection section has
a second flow path forming section having a second supply port that communicates with the material supply section and to which the material is supplied, and a second flow path that communicates with the second supply port and
a second nozzle section that communicates with the second flow path and that has a third nozzle and a fourth nozzle that are configured to eject the material,
the first nozzle, the second nozzle, the third nozzle, and the fourth nozzle are arranged along a first direction parallel to the molding surface, and
among the first nozzle section and the second nozzle section, at least the first nozzle, the second nozzle, the third nozzle, and the fourth nozzle are formed in a single member.

2. The three dimensional molding device according to claim 1, wherein
the first flow path has a first branch flow path,
the first nozzle section has
a first nozzle flow path that communicates with the first branch flow path and the first nozzle and
a second nozzle flow path that communicates with the first branch flow path and the second nozzle,
the second flow path has a second branch flow path,
the second nozzle section has
a third nozzle flow path that communicates with the second branch flow path and the third nozzle and
a fourth nozzle flow path that communicates with the second branch flow path and the fourth nozzle, and
the first nozzle flow path, the second nozzle flow path, the third nozzle flow path, and the fourth nozzle flow path are formed in the single member.

3. The three dimensional molding device according to claim 1, further comprising:
a first connection section that is a columnar member configured to connect a lower surface of the material supply section and an upper surface of the first ejection section, wherein
the lower surface of the material supply section or the upper surface of the first ejection section has a first hole into which the first connection section is inserted and
a size of the first hole in the first direction is larger than a size of the first hole in a direction intersecting the first direction and parallel to the molding surface.

4. The three dimensional molding device according to claim 3, further comprising:
a second connection section that is a columnar member configured to connect the lower surface of the material supply section and the upper surface of the first ejection section, wherein
the lower surface of the material supply section or the upper surface of the first ejection section has a second hole into which the second connection section is inserted,
a distance between the first hole and the second ejection section in the first direction is larger than a distance between the second hole and the second ejection section in the first direction, and
the size of the first hole in the first direction is larger than a size of the second hole in the first direction.

5. The three dimensional molding device according to claim 1, further comprising:
a first connection section that is a columnar member configured to connect a lower surface of the material supply section and an upper surface of the first ejection section, wherein
the lower surface of the material supply section or the upper surface of the first ejection section has a first hole into which the first connection section is inserted and
a size of the first connection section in the first direction is smaller than a size of the first connection section in a direction that intersects the first direction and that is parallel to the molding surface.

6. The three dimensional molding device according to claim 5, further comprising:
a second connection section that is a columnar member configured to connect the lower surface of the material supply section and the upper surface of the first ejection section, wherein
the lower surface of the material supply section or the upper surface of the first ejection section has a second hole into which the second connection section is inserted,
a distance between the first hole and the second ejection section in the first direction is larger than a distance between the second hole and the second ejection section in the first direction, and
the size of the first connection section in the first direction is smaller than a size of the second connection section in the first direction.

7. The three dimensional molding device according to claim 1, wherein
the material supply section includes a plasticizing section configured to plasticize the material and
the first supply port and the second supply port communicate with the plasticizing section.

8. The three dimensional molding device according to claim 1, further comprising:
a nozzle heating section configured to heat the first ejection section and the second ejection section, wherein
the nozzle heating section extends along the first direction and
the nozzle heating section is positioned to overlap the first ejection section and the second ejection section as viewed from a second direction, which is a direction parallel to the molding surface and is orthogonal to the first direction.

9. The three dimensional molding device according to claim 1, further comprising:
a pressing section configured to press the material deposited on the molding surface, wherein
the pressing section extends along the first direction and
the pressing section is positioned to overlap the first ejection section and the second ejection section as viewed from a second direction, which is a direction parallel to the molding surface and is orthogonal to the first direction.

10. A material ejection head that ejects a material to a stage, the material ejection head comprising:
a first ejection section and a second ejection section configured to eject the material, wherein
the first ejection section has
a first flow path forming section having a first supply port to which the material is supplied and a first flow path communicating with the first supply port and
a first nozzle section that communicates with the first flow path and that has a first nozzle and a second nozzle, which are configured to eject the material,
the second ejection section has
a second flow path forming section having a second supply port to which the material is supplied and a second flow path communicating with the second supply port and
a second nozzle section that communicates with the second flow path and that has a third nozzle and a fourth nozzle that are configured to eject the material,
the first nozzle, the second nozzle, the third nozzle, and the fourth nozzle are arranged along a first direction parallel to a surface of the stage, and
among the first nozzle section and the second nozzle section, at least the first nozzle, the second nozzle, the third nozzle, and the fourth nozzle are formed in a single member.
